(19) United States
(12) Patent Application Publication
(10) Pub. No.: US 2026/0045570 A1
(43) Pub. Date: Feb. 12, 2026

(54) Sensor for Detecting and Locating High Temperature of lithium-ion Battery and Battery Pack and Detection Method Thereof

(71) Applicant: Nanjing Tech University, Nanjing City (CN)

(72) Inventors: Zhirong Wang, Nanjing City (CN); Jinlong Bai, Nanjing City (CN); Yun Yang, Nanjing City (CN)

(21) Appl. No.: 19/264,819

(22) Filed: Jul. 9, 2025

(30) Foreign Application Priority Data
Aug. 8, 2024 (CN) 202411082280.5

(51) Int. Cl. H01M 10/48; G01K 5/48; G01K 5/72; H01M 10/0525; H01M 10/0587

(52) U.S. Cl. CPC H01M 10/486; G01K 5/483; G01K 5/72; H01M 10/0525; H01M 10/0587; G01K 2213/00

(57) ABSTRACT

The present invention relates to the technical field of thermal runaway management for lithium-ion batteries, and more particularly to a method for detecting and locating overheating in lithium-ion batteries or battery packs using temperature sensors. The temperature sensor is based on a shape memory alloy or bimetallic strips. The lithium-ion batteries or battery packs are equipped with these temperature sensors and arranged in a matrix configuration, enabling detection and localization of overheated batteries within the pack. This method addresses the challenge of identifying overheating in large-scale battery packs and energy storage power stations, thereby improving the efficiency of detection and localization. It also facilitates timely identification and precise location of batteries that may be undergoing thermal runaway.

### TECHNICAL FIELD

The present invention is in the technical field of lithium-ion battery thermal runaway detection, and in particular relates to a temperature sensor embedded inside a lithium-ion battery and a method for detecting overheated batteries using such a sensor.

### BACKGROUND ART

During the charging and discharging processes of lithium-ion batteries, the heat generated by the intercalation, deintercalation, and movement of lithium-ions between the positive electrode and negative electrode materials causes the battery temperature to rise. Additionally, high ambient temperatures and harsh operating conditions can also lead to an increase in battery temperature. When a lithium-ion battery overheats, side reactions occur internally, adversely affecting battery performance and reducing stability. If the temperature exceeds the thermal runaway threshold, it can rapidly trigger thermal runaway, producing large amounts of toxic fumes, flames, or even explosions. Furthermore, due to the densely packed arrangement of batteries in a battery pack, the substantial heat released by one battery undergoing thermal runaway can induce thermal runaway in adjacent batteries, potentially leading to a fire across the entire battery pack. In large-scale energy storage systems or battery warehouses, this may result in severe accidents.

Therefore, rapid and reliable temperature monitoring of batteries is crucial for the safe large-scale application of lithium-ion batteries. However, lithium-ion battery packs consist of numerous individual cells, making it difficult for conventional temperature sensors to be attached to each one. Moreover, deploying too many sensors increases the complexity of the detection circuitry, complicating the development and maintenance of the temperature monitoring system. Additionally, heat generation occurs inside the battery, and time is required for internal high temperatures to conduct to the surface, and the temperature of the surface of the battery is non-uniform in each region. Traditional temperature sensors, such as thermocouples or thermistors, even when attached to the battery surface, can only perform point measurements, making them incapable of detecting temperature imbalances across the battery surface. Some existing solutions employ optical fibers embedded in batteries for internal temperature measurement, which can accurately capture internal temperatures. However, fiber-optic sensing requires stringent environmental conditions, and the associated transceiver and processing equipment are prohibitively expensive, limiting their current use to laboratory-scale applications. Therefore, there is an urgent need for a battery temperature sensor, which is inexpensive, easy to detect, reliable in signal, and easy to arrange in a wide range, for detecting and locating the overheated batteries in real time.

### SUMMARY OF THE INVENTION

The present invention provides a sensor for detecting and locating a high temperature of a lithium-ion battery, a battery pack, and a detection method thereof, for detecting and locating a large number of overheated batteries of the battery pack and an energy storage power station, and improving the detection and location efficiency.

In order to achieve the above-mentioned objective, the present invention is achieved by the following solution:
a temperature sensor includes a case, a central shaft and a bushing, where the central shaft and the bushing are provided in the case, and the case is electrically insulated from the central shaft; the bushing is a metal component including a fixed end fixedly connected to the central shaft, a sliding end slidably connected to the central shaft, and a thermally-responsive deformation segment located between the fixed end and the sliding end, the thermally-responsive deformation segment is made of a temperature-variable metal material, and when the temperature reaches a deformation threshold of the thermally-responsive deformation segment, the thermally-responsive deformation segment deforms to form an arch shape, so that the sliding end approaches the fixed end, and the thermally-responsive deformation segment abuts against the case and is electrically connected to the case.

The temperature-variable metal according to the present invention refers to a metal that changes in shape when a temperature changes.

Preferably, the case includes a metal case body and an end cap made of an electrically insulating material arranged at two ends of the metal case body, and the central shaft is detachably connected to the end cap; the end cap is detachably connected to the case body; the central shaft is of a hollow tubular structure and is made of a metal material, and a unidirectional conducting diode is encapsulated in the hollow of the central shaft, and an anode of the diode is electrically connected to an inner side wall of the central shaft; the case further includes two lead-out terminals of a terminal A and a terminal B, where the terminal B is electrically connected to the case, the terminal A is electrically connected to a cathode of the diode, and the terminal A is electrically insulated from the central shaft; the thermally-responsive deformation segment is a metal sheet made of a memory alloy or a bimetal sheet formed by superposing two bimetallic strips with different thermal expansion coefficients.

The memory alloy can be deformed and restored to its original shape at different temperatures, and it can be repeatedly used for temperature detection up to several hundred thousand times using this property, so that it can be used for a long period of time without worrying about the reliability of detection. The present invention utilizes the characteristic of shape memory alloys that deform at high temperatures and return to their original shape upon temperature reduction to detect the overheated batteries. Alternatively, the property of bimetallic strips exhibiting different shapes at different temperatures can also be employed for detecting temperatures of the overheated batteries.

Preferably, there are a plurality of metal sheets in the thermally-responsive deformation segment, and the plurality of metal sheets are uniformly arranged in the circumferential direction of the central shaft; when deformed at a high temperature, the bushing is of a lantern-frame structural configuration as a whole. Such a design ensures omnidirectional uniformity of the sensor, meaning that regardless of which direction inside the battery experiences high temperature, it can cause deformation of at least one thermally-responsive deformation segment, thereby enabling high-temperature detection unaffected by the sensor's installation position and achieving high detection accuracy.

A lithium-ion battery including temperature sensors, where at least one temperature sensor is embedded within an interior of the lithium-ion battery, a terminal A of each temperature sensor in each battery is connected to a common lead-out wire designated as a battery unit aggregate terminal A, and a terminal B of each temperature sensor is connected to a common lead-out wire designated as a battery unit aggregate terminal B.

Preferably, the shape of the lithium-ion battery is cylindrical and the temperature sensor is arranged in a cavity of a wound battery center core pillar within the interior of the lithium-ion battery.

Preferably, the lithium-ion battery is prismatic, and the temperature sensor is provided in a corner cavity inside the lithium-ion battery.

A lithium-ion battery pack assembled from the above-mentioned lithium-ion battery pack, where the plurality of lithium-ion batteries are arranged in M rows and N columns of lithium-ion battery pack in the form of a matrix of rows and columns;
the battery unit terminal A of each row of lithium-ion batteries is connected to a common lead-out wire so as to be designated as a row lead-out terminal, and there are M row lead-out terminals in total, and each row lead-out terminal corresponds to one unique number Lᵢ, i∈[1,M]; the battery unit terminal B of each column of lithium-ion batteries is connected to a common lead-out wire and is referred to as a column lead-out terminal, there are N row lead-out terminals in total, and each row lead-out terminal corresponds to one unique number Iⱼ, j∈[1,N]; each battery then corresponds to a unique number Batᵢⱼ.

In a fourth aspect, the present invention provides a method for detecting and locating overheated batteries in a lithium-ion battery pack as described above:
including a first multiplexer having M input terminals and one first output terminal;
a second multiplexer having N input terminals and one second output terminal;
a power supply serving as a DC working power supply for detecting the overheated lithium-ion batteries;
a fixed value resistor having one end electrically connected to a second output terminal of the second multiplexer and the other end electrically connected to a positive electrode of the power supply. The resistance value of the fixed value resistor is relatively large, so that when a conductive path is formed, the total resistance value of the wires and other components in the circuit is much smaller than the resistance value of the fixed value resistor, and then the voltage across the fixed value resistor is relatively large, so as to make it easy for a voltage meter to obviously detect.

The voltage meter is connected in parallel to the fixed value resistor;

The method for detecting and locating the overheated batteries includes the following steps:

### Step One S1: Circuit Connections

electrically connecting M input terminals of the first multiplexer to row lead-out terminals of M rows of lithium-ion batteries correspondingly, i.e., electrically connecting an i^{th} input terminals of the first multiplexer to a row lead-out terminal Lᵢ of an i^{th} row of lithium-ion battery, and electrically connecting a first output terminal of the first multiplexer to a negative electrode of the power supply; and
respectively electrically connecting N input terminals of the second multiplexer to column lead-out terminals of corresponding N columns of lithium-ion batteries, i.e., electrically connecting a j^{th} input terminals of the second multiplexer to a column lead-out terminal Iⱼ of the corresponding j^{th} column of the lithium-ion battery, and electrically connecting a second output terminal of the second multiplexer to a positive electrode of the power supply via the fixed value resistor;

### Step Two S2: Detection and Location of Overheated Batteries

S2-1: firstly switching the input terminals of the first multiplexer to a first input terminal, and keeping first row lead-out terminals connected to a negative electrode of the power supply;
S2-2: then switching the input terminals of the second multiplexer to the first input terminal, and keeping first column lead-out terminals connected to the positive electrode of the power supply;
S2-3: observing the voltage meter, and if there is no voltage, a first row first column of a lithium-ion battery Bat₁₁ does not overheat; and if a voltage increases, the first row first column of the lithium-ion battery Bat₁₁ overheats;
S2-4: switching the input terminals of the second multiplexer to a second input terminal, and keeping second column lead-out terminals connected to the positive electrode of the power supply;
S2-5: observing the voltage meter, and if there is no voltage, a first row second column of a lithium-ion battery Bat₁₂ does not overheat; and if a voltage increases, the first row second column of a lithium-ion battery Bat₁₂ overheats;
S2-6: switching the input terminals of the second multiplexer to a third input terminal, and repeating steps S2-4 and S2-5 until the input terminals of the second multiplexer is switched to an N^{th} input terminal, and ending detection of whether a first row of a lithium-ion battery Bat₁ⱼ overheats;
S2-7: switching the input terminals of the first multiplexer to the second input terminal, and keeping a second row lead-out terminal connected to the negative electrode of the power supply; successively switching the input terminals of the second multiplexer from the first input terminal to the N^{th} input terminal, and ending detection of whether a second row of a lithium-ion battery Bat₂ⱼ overheats;
S2-8: successively switching the input terminals of the first multiplexer to the third input terminal, and keeping a third row lead-out terminal connected to the negative electrode of the power supply; successively switching the input terminals of the second multiplexer from the first input terminal to the N^{th} input terminal, and ending whether a third row of a lithium-ion battery Bat₃ⱼ overheats;
. . .
S2-9: switching the input terminals of the first multiplexer to the i^{th} input terminal, and sequentially switching the input terminals of the second multiplexer from the first input terminal to the N^{th} input terminal, and ending detection of whether the i^{th} row of the lithium-ion battery Batᵢⱼ overheats; and
S2-10: repeating steps 2-9 until the input terminals of the first multiplexer is switched to the M^{th} input terminal, and sequentially switching the input terminals of the second multiplexer from the first input terminal to the N^{th} input terminal, and ending detection of whether the Mth row of the lithium-ion battery Bat_{Mj} overheats; i.e., completing overall battery pack overheating detection.

The advantageous effects of the present invention over the prior art are as follows:
1. The temperature sensor according to the present invention utilizes metal with temperature memory effect or bimetallic strips, which undergo special structural design specifically for detecting overheating inside batteries, providing higher sensitivity compared to external detection; using short-circuit signals as overheating detection signals simplifies the detection circuit and ensures more reliable signal presence/absence determination.
2. A case of the temperature sensor can be manufactured into cylindrical shape as required, or alternatively into elliptical, triangular or rectangular prismatic shapes according to the form and length of voids inside batteries, enabling adaptation to differently shaped internal battery voids for overheating detection. With simple and compact internal structure, the sensor can be installed in unused spaces within batteries, simultaneously enhancing overall battery strength while achieving overheating detection functionality.
3. By connecting all temperature sensors in a battery pack into circuits to form a matrix-type battery pack overheating detection system, where each temperature sensor incorporates an internally embedded diode ensuring unidirectional conductivity, and combining with external matrix circuits, a plurality of overheated batteries can be detected and located, achieving full battery pack overheating detection with simple circuitry.
4. Owing to the temperature sensor's simple structure and convenient detection capability, it can be effectively applied in vehicle battery packs and large-scale energy storage battery systems, enabling low-cost individual and a plurality of overheated battery localization within battery packs, and facilitating integration of the sensor and detection method disclosed in this patent with other systems.

### BRIEF DESCRIPTION OF THE DRAWINGS

FIG. 1 is an exploded view showing a temperature sensor according to Embodiment 1;

FIG. 2 is a schematic diagram showing a shape of a bushing at a high temperature according to Embodiment 2;

FIG. 3 is a schematic diagram showing a temperature sensor in a low temperature state according to Embodiment 2, where an upper part is a simplified logic diagram showing the temperature sensor, and a lower part is a cross-sectional view showing the temperature sensor;

FIG. 4 is a schematic diagram showing a temperature sensor in a high temperature state according to Embodiment 2, where an upper part is a simplified logic diagram showing the temperature sensor, and a lower part is a cross-sectional view showing the temperature sensor;

FIG. 5 is a schematic cross-sectional view showing a battery after a temperature sensor is combined with a cylindrical battery according to Embodiment 3;

FIG. 6 is a schematic cross-sectional view showing a battery in which a temperature sensor is combined with a prismatic battery according to Embodiment 4;

FIG. 7 is a schematic diagram showing a system for detecting overheated lithium-ion batteries using a temperature sensor according to Embodiment 5.

FIG. 8 is a schematic diagram showing a system for detecting overheated lithium-ion batteries using a temperature sensor that does not include a diode; and

FIG. 9 is a schematic diagram showing a system for detecting overheated lithium-ion batteries using a temperature sensor including a diode.

In the figure: 100. Temperature sensor; 101. case; 1011. Metal case body; 1012. End cap; 102. Central shaft; 103. Bushing; 1031. Fixed end; 1032. Thermally-responsive deformation segment; 1033. Sliding end; 104. Diode; 105. Terminal B; 106. Terminal A; 200. Cylindrical lithium-ion battery; 201. Cylindrical battery case; 202. Cylindrical battery cell; 203. Battery center core pillar; 300. Prismatic lithium-ion battery; 301. Prismatic battery case; 302. Prismatic battery cell; 5011. First multiplexer; 5012. Second multiplexer; 502. Power supply; 503. Fixed value resistor; 504. Voltage meter.

### DETAILED DESCRIPTION OF THE INVENTION

The subject matter described herein will now be discussed with reference to example embodiments. It is to be understood that these embodiments are discussed merely to enable a person skilled in the art to better understand the subject matter described herein, and that changes may be made in the function and arrangement of elements discussed without departing from the scope of the present disclosure. Various examples may omit, replace, or add various processes or components as desired. In addition, features described with respect to some examples may also be combined in other examples.

### Embodiment 1

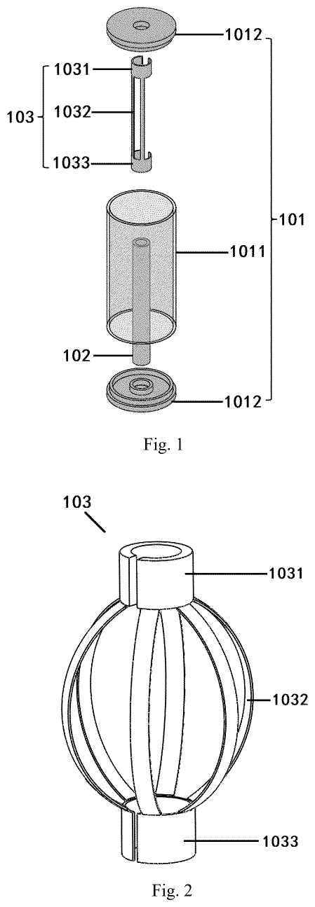

Referring to FIG. 1, a temperature sensor 100 includes a case 101 made of a metal material, a central shaft 102 and a bushing 103 made of a memory alloy material, the central shaft 102 and the bushing 103 are provided in the case 101, and the case 101 is electrically insulated from the central shaft 102.

The electrical insulation between the case 101 and the central shaft 102 is achieved in such a way that A case 101 including a metal case body 1011 and end caps 1012 made of an electrically insulating material arranged at two ends of the metal case body 1011, where the end caps 1012 are provided with a large annular protrusion adapted to the inner diameter of the case body 1011 and a small annular protrusion adapted to the outer diameter of the central shaft 102, the end caps 1012 adapted to the position of the small annular protrusion are provided with through holes, the central shaft 102 is inserted into the small annular protrusions of the two end caps 1012, and the central shaft 102 is detachably connected to the end caps 1012; the case body 1011 is inserted over the large annular protrusion of two end caps 1012, the end caps 1012 being detachably connected to the case body 1011, and the central shaft 102 not contacting the case body 1011.

The two ends of the bushing 103 each have one annular ring, where the annular ring can be a closed annular ring or an open annular ring, the open annular ring is better installed and fixed relative to the closed annular ring, and the open annular ring is also better adapted to thermal expansion and contraction changes, where a fixed end 1031 has a smaller inner diameter, and a sliding end 1033 has a larger inner diameter; the fixed end 1031 is fixedly connected to the central shaft 102 and is electrically connected, for example, by riveting or spot welding, and the sliding end 1033 can slide on the central shaft 102; and a thermally-responsive deformation segment 1032 is located between the fixed end 1031 and the sliding end 1033. When the temperature reaches the deformation threshold of the thermally-responsive deformation segment 1032, the thermally-responsive deformation segment 1032 deforms into a dome shape, so that the sliding end approaches the fixed end, and the thermally-responsive deformation segment 1032 abuts against the case 101 and is electrically connected to the case 101.

The thermally-responsive deformation segment 1032 is a nickel-titanium memory alloy with a two-way memory effect. Generally, since the safe operating temperature of a lithium-ion battery is 0-50° C., and the starting temperature of exothermic side reactions inside the lithium-ion battery is about 75° C., a deformation threshold is preferably 60° C., and when reaching 60° C., a bending deformation occurs, and a flat memory alloy is recovered as the material of the thermally-responsive deformation segment at 40° C.

The number of the metal sheets of the thermally-responsive deformation segment 1032 is plural, and the term “a plurality of” in the present invention means two or more, and in the present embodiment, the number of the metal sheets of the thermally-responsive deformation segment 1032 is two.

The central shaft 102 has a hollow tubular structure, where through holes on both end caps 1012 communicate with the hollow portion of the central shaft 102, a unidirectional conducting diode 104 is encapsulated within the hollow portion of the central shaft 102, and an anode of the diode 104 is electrically connected to the central shaft 102.

The temperature sensor 100 also includes two lead-out terminals, namely a terminal A 106 and a terminal B 105, where the terminal B 105 is electrically connected to the case 101, the terminal A 106 is electrically connected to a cathode of the diode 104, and the terminal A 106 is insulated from the central shaft 102, e.g., an insulating outer sleeve is placed over one of the sections of the terminal A 106 that may contact the central shaft 102.

In other embodiments, the thermally-responsive deformation segment may be formed from a bimetallic strip, which is formed by joining two metal sheets (e.g., a copper sheet and an iron sheet) having the same size and different thermal expansion coefficients, e.g., by riveting or welding. Since the thermally-responsive deformation segment 1032 is required to undergo bending deformation at elevated temperatures and restore its original flat shape upon cooling, with a preferred deformation threshold of 60° C., the design of metal sheet thickness and configuration achieves bending deformation at 60° C. and shape recovery at 40° C., making bimetallic strips suitable as the material for thermally-responsive deformation segment 1032.

The bimetallic strips offer advantages of readily available materials and low manufacturing costs.

### Embodiment 2

Referring to FIGS. 2-4, the present embodiment differs from Embodiment 1 in that the thermally-responsive deformation segment 1032 is formed of six metal sheets, and the six metal sheets are uniformly arranged in the circumferential direction of the central shaft 102. During high-temperature deformation, the bushing 103 entirely assumes a lantern-frame structural configuration.

The advantage of the present embodiment is that the thermally-responsive deformation segment 1032 has a large contact area with the case 101 and is structurally stable.

The rest is the same as that in Embodiment 1.

The above-described two examples of temperature sensor 100 correspond to temperature control switches.

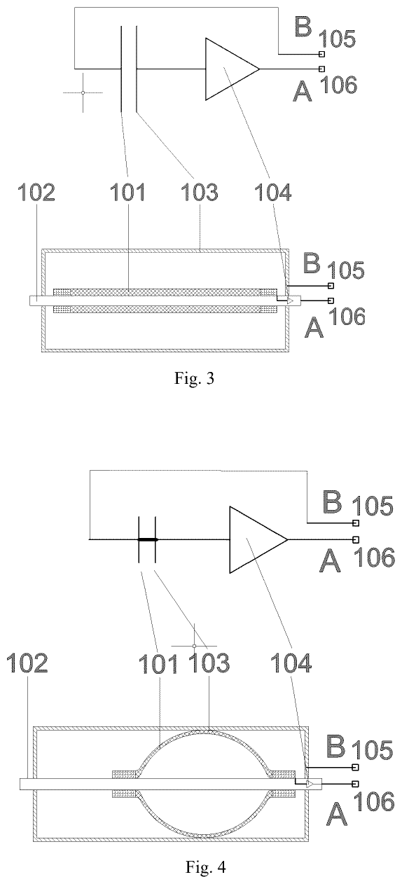

With reference to FIG. 3, at a low temperature, when the thermally-responsive deformation segment 1032 is not arched up and contracts and closes, the bushing 103 and the case 101 do not abut, and since the bushing 103 is fixedly connected to the central shaft 102 via the fixed end 1031, the case 101 and the central shaft 102 are not electrically connected, which is equivalent to the switch being in an off state.

Referring to FIG. 4, at a high temperature, the thermally-responsive deformation segment is arched up away from the central shaft 102 until abutting against an inner wall of the case 101, since the bushing 103 and the case 101 are both made of metal, when they abut against each other, they are electrically connected, which is equivalent to the switch being in a switched on state.

### Embodiment 3

In the present embodiment, the temperature sensor 100 of Embodiments 1 and 2 is embedded in a cylindrical lithium-ion battery 200 for detecting overheating of the lithium-ion battery 200.

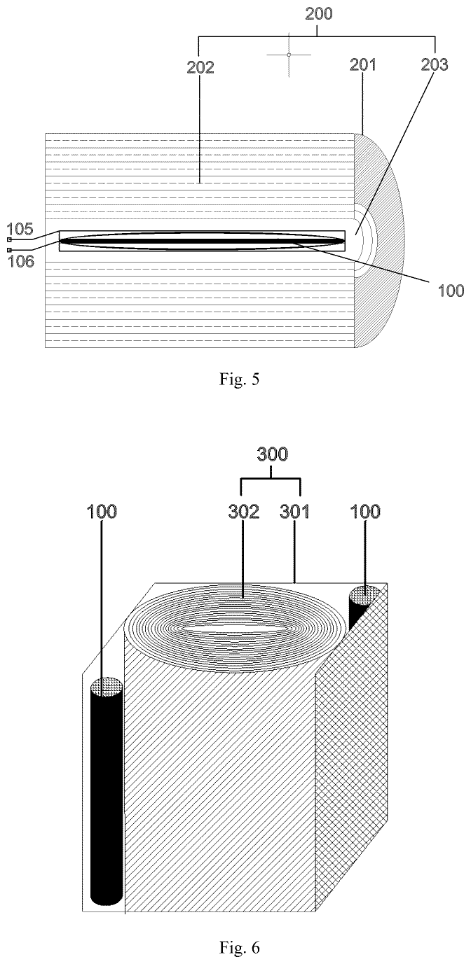

Referring to FIG. 5, a cylindrical lithium-ion battery 200 includes a cylindrical battery case 201, a cylindrical battery cell 202 and a battery center core pillar 203, where the cylindrical battery cell 202 has a winding structure inside the cylindrical battery cell 200, and a cylindrical hollow space exists in a central part of the winding cell, and this space is generally provided with a cylindrical battery center core pillar 203, so as to improve the stability and mechanical strength of the battery cell. At least one of the above-described temperature sensors 100 as a battery center core pillar 203 is inserted into the interior of the cylindrical battery 200 at the battery manufacturing stage, thereby detecting overheating of the battery from the interior.

### Embodiment 4

In the present embodiment, the temperature sensor 100 according to Embodiments 1 and 2 is embedded in the prismatic lithium-ion battery 300, so as to detect overheating of the lithium-ion battery 300.

As shown in FIG. 6, the above-mentioned temperature sensor 100 is embedded during the manufacture of the prismatic lithium-ion battery 300, and is used to detect and locate overheating of the prismatic lithium-ion battery 300. Inside the prismatic lithium-ion battery 300 is a prismatic battery cell 302 with a winding structure, and each corner of the cell 302 is formed in an arc shape due to the winding structure, so that the prismatic battery cell 302 and the prismatic battery case 301 form a triangular-like void at each corner. In the manufacturing stage of the prismatic lithium-ion battery 300, the temperature sensors 100 may be placed in this void to detect overheating inside the prismatic lithium-ion battery 300. In addition, the case 101 of the temperature sensor 100 may be formed in various other shapes to accommodate the shape and length of the void of the battery, such as an elliptical column shape, a triangular column shape, or a prismatic column shape, and the shape and length of the bushing 103 on an inner central shaft 102 of the sensor may be adapted to the case 101 to ensure that the overheating of the battery can be detected over the entire length of the sensor.

In the third and fourth embodiments, if there are a plurality of temperature sensors 100, the terminal A 106 of each temperature sensor 100 is connected to the same lead-out wire, which is designated as a battery unit aggregate terminal A, and the terminal B 105 of each temperature sensor 100 is connected to the same lead-out wire, which is designated as a battery unit aggregate terminal B.

### Embodiment 5

According to Embodiments 1 and 2, the temperature sensor 100 can be simplified as a logic structure as shown in FIGS. 3 and 4, and the temperature sensor 100 is regarded as one switch which is automatically switched on at a high temperature and automatically switched off at a low temperature, and the temperature sensor 100 can only unidirectionally conducting an external circuit since the central shaft 102 incorporates a built-in diode 104.

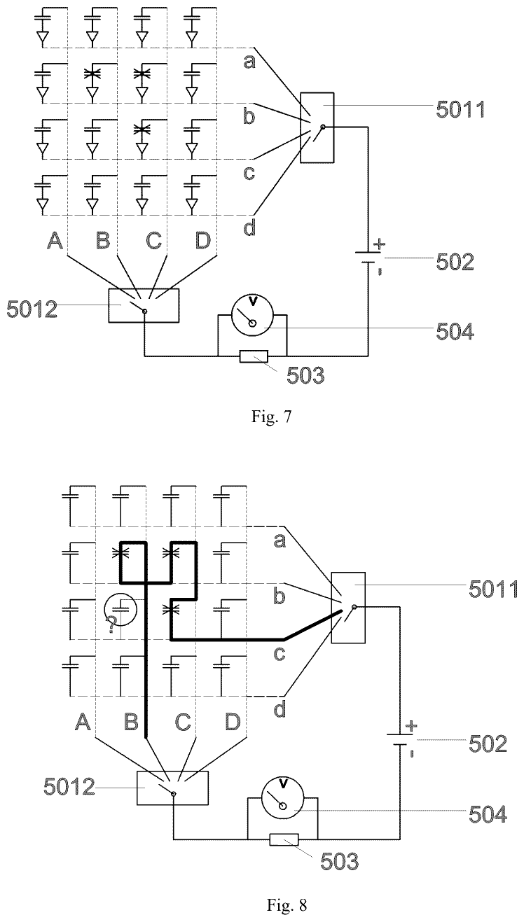

Referring to FIG. 7, the present embodiment arranges a plurality of lithium-ion batteries according to Embodiment 3 or 4 into an M-row N-column lithium-ion battery pack in a row-column matrix configuration, where the battery unit aggregate terminal A in each row of lithium-ion batteries is connected to a common lead-out wire and referred to as a row lead-out terminal, and the battery unit aggregate terminal B in each column of lithium-ion batteries is connected to a common lead-out wire and referred to as a column lead-out terminal, enabling overheating of the lithium-ion batteries in this battery pack to be detected and located.

To achieve detection and localization of the overheated batteries, sensors at different positions may form an overheated battery detection and localization matrix circuit as shown in FIG. 7, the present embodiment uses a four row four column matrix for illustration, while the overheating detection and localization logic for larger sensor matrices may be derived with reference to the present embodiment.

During the test, the following components are used: a first multiplexer 5011 having four input terminals and one first output terminal;
a second multiplexer 5012 having four input terminals and one second output terminal;
a power supply 502 serving as a DC working power supply for detecting the overheated lithium-ion batteries;
a fixed value resistor 503 having one end electrically connected to a second output terminal of the second multiplexer 5012 and the other end electrically connected to a positive electrode of the power supply 502; and the resistance value of the fixed value resistor 503 is relatively large, so that a voltage value which can be clearly observed by a voltage meter 504 can be formed on the two ends of the fixed value resistor 503. For example, a rated voltage of the power supply is 5 v, the resistance value of the fixed value resistor 503 is 1000 Ohm, and the resistance values of the wires and other elements in the circuit are always several Ohms or tens of Ohms, so that when the temperature sensor 100 is switched on, the voltage formed across the fixed value resistor 503 is close to 5 v, and the change of the value on the voltage meter 504 can be clearly observed.

The voltage meter 504 is connected in parallel to the fixed value resistor 503;
the specific method for detecting and locating the overheated batteries includes the following steps:

### Step One S1: Circuit Connections

Referring to FIGS. 7-9, the row lead-out terminals of each battery row are respectively connected to one of the input terminals of the first multiplexer 5011, with the row lead-out terminals of rows 1-4 sequentially assigned from top to bottom as input terminals a, b, c, d of the first multiplexer 5011, specifically the row lead-out terminal of the first row being electrically connected to an input terminal A of the first multiplexer 5011, the row lead-out terminal of the second row being electrically connected to an input terminal B . . . ; the column lead-out terminals of each battery column are respectively connected to one of the input terminals of the second multiplexer 5012, with the column lead-out terminals of columns 1-4 sequentially assigned from left to right as input terminals A, B, C, D of the second multiplexer 5012, specifically the column lead-out terminal of the first column being electrically connected to the input terminal A of the second multiplexer 5012, the column lead-out terminal of the second column being electrically connected to the input terminal B . . . . Therefore, each battery corresponds to a unique matrix identifier, where the battery at the third row second column position is numbered as cB and the battery at the fourth row third column position is numbered as dC.

After the input terminals of the first multiplexer 5011 are connected to a row lead-out terminal, the output terminals of the first multiplexer 5011 are connected to a negative electrode of the power supply 502; after the input terminals of the second multiplexer 5012 are connected to the column lead-out terminal, the output terminals of the second multiplexer 5012 are connected to a positive electrode of the power supply 502 via a fixed value resistor 503;

### Step Two S2: Detection and Location of Overheated Batteries

S2-1: the input terminals of the first multiplexer 5011 are firstly switched to a first input terminal, and first row lead-out terminals are kept to be connected to a negative electrode of the power supply 502;
S2-2: then the input terminals of the second multiplexer 5012 are switched to the first input terminal, and first column lead-out terminals are kept to be connected to a positive electrode of the power supply 502;
S2-3: the voltage meter 504 is observed, and if there is no voltage, a first row first column of the lithium-ion battery (corresponding number is aA) does not overheat; if a voltage increases, the first row first column of the lithium-ion battery (corresponding number is aA) overheats;
S2-4: the input terminals of the second multiplexer 5012 are switched to a second input terminal, and second column lead-out terminals are connected to a positive electrode of the power supply 502;
S2-5: the voltage meter 504 is observed, and if there is no voltage, a first row second column of the lithium-ion battery (corresponding number is aB) does not overheat; if a voltage increases, the first row second column of the lithium-ion battery (corresponding number is aB) overheats;
S2-6: the input terminals of the second multiplexer 5012 are switched to a third input terminal, steps S2-4 and S2-5 are repeated until the input terminals of the second multiplexer 5012 are switched to a fourth input terminal, and the detection and location of whether the first row of the lithium-ion batteries aA, aB, aC and aD overheats are ended;
S2-7: the input terminals of the first multiplexer 5011 are switched to the second input terminal, and second row of lead-out terminals are kept to be connected to the negative electrode of the power supply 502; the input terminals of the second multiplexer 5012 are successively switched from the first input terminal to the fourth input terminal, and the detection and location of whether a second row of lithium-ion batteries bA, bB, bC and bD in the second row overheats are ended;
S2-8: the input terminals of the first multiplexer 5011 are successively switched to the third input terminal, and a third row of lead-out terminals are kept to be connected to the negative electrode of the power supply 502; the input terminals of the second multiplexer (5012) are successively switched from the first input terminal to the fourth input terminal, and the detection and location of whether a third row of lithium-ion batteries cA, cB, cC and cD overheats are ended;
S2-9: the input terminals of the first multiplexer 5011 are successively switched to a fourth input terminal, and a fourth row of lead-out terminals is kept to be connected to a negative electrode of the power supply 502; the input terminals of the second multiplexer (5012) are successively switched from the first input terminal to the fourth input terminal, and the detection and location of whether a fourth row of the lithium-ion batteries dA, dB, dC, and dD overheats are ended;
S2-10: completion of overall battery pack overheating detection.

Specifically, when all the batteries are not overheated and there is an open circuit between the fixed value resistor 503 and the power supply 502 in the circuit, a voltage cannot be detected across the fixed value resistor 503. When one of the batteries in the battery pack overheats, a conductive path is formed between the fixed value resistor 503 and the power supply 502, and a large voltage can be detected across the fixed value resistor 503 at this time. The specific process involves: the horizontally-connected multiplexer 501 cyclically connects different horizontal circuits into the circuit while the vertically-connected multiplexer 502 cyclically connects different vertical circuits into the circuit, with the frequency set such that the horizontally-connected multiplexer 501 switches to the next horizontal circuit only after the vertically-connected multiplexer 502 has completed one full cycle of connecting all vertical circuits into the circuit. When all horizontal circuits have been cyclically connected into the circuit by the multiplexer 501 for one complete period, all possible connection combinations in the matrix sensor are systematically scanned, and by recording which sensor-designated connections produce detectable voltage across the fixed value resistor during circuit connection, the battery positions corresponding to these sensors are identified as being in an overheated state. For instance, when a second row fourth column of battery overheats, its installed temperature sensor 100 will be switched on to form a conductive path. Consequently, when horizontal circuit b and vertical circuit D are connected into the circuit by the multiplexer 501, a voltage becomes detectable across the fixed value resistor 503, enabling determination of the overheated battery location through this voltage signal combined with a sensor number bD. Similarly, when a plurality of batteries in the battery pack overheat, a plurality of sensor numbers will be identified, allowing rapid localization of a plurality of overheated batteries.

Alternatively, a light-emitting diode may replace a voltage meter 504, with the LED's negative electrode electrically connected to the second input terminal of second multiplexer 5012 and the LED's negative electrode also connected to the negative terminal of power supply 502. If an overheated lithium-ion battery is detected, the LED will illuminate, providing more convenient and intuitive indication compared to using the voltage meter 504 for voltage measurement.

In the present application, the diode 104 in the temperature sensor 100 is specifically designed to detect and localize overheated batteries in multi-cell battery packs as described in the embodiments. Without the diode 104, the occurrence of a plurality of overheated batteries could cause the system to erroneously mark non-overheated batteries as overheated.

As shown in FIG. 8, FIG. 8 is a schematic diagram showing a system for detecting overheated lithium-ion batteries using a temperature sensor that does not include a diode, sensors lacking the diode 104 would constitute the described sensor matrix. When the batteries at positions numbered bB, bC, and cC are overheated, these three sensors maintain conductive paths. Due to the sensors' non-unidirectional conductivity, current can bypass a sensor numbered cB through a bolded path in the diagram, causing horizontal circuit c and vertical circuit B to present a conductive path when connected into the detection circuit, which results in detectable voltage across the fixed value resistor 503 even though the sensor numbered cB remains non-conductive.

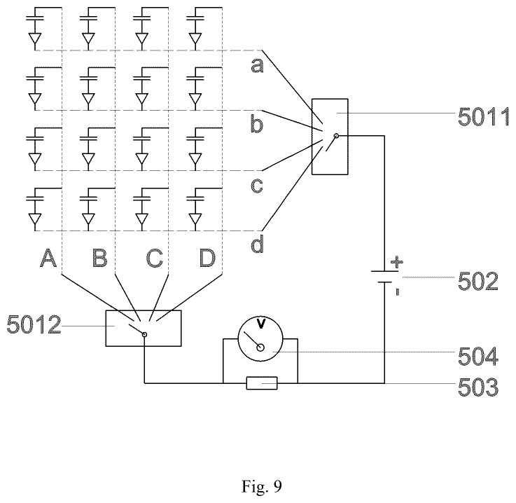

As shown in FIG. 9, FIG. 9 is a schematic diagram showing a system for detecting overheated lithium-ion batteries using a temperature sensor 100 including a unidirectional conducting diode 104.

With the diode 104 incorporated, since the detection circuit uses DC power as the power supply, current cannot reversely pass through the sensor numbered bC, preventing the detection circuit from falsely identifying the non-overheated batteries as overheated (false alarms).

1. A lithium-ion battery comprising one or more temperature sensors, wherein each temperature sensor (100) is embedded within an interior of the lithium-ion battery, a terminal A (106) of each temperature sensor (100) in each battery is connected to a common lead-out wire designated as a battery unit aggregate terminal A, and a terminal B (105) of each temperature sensor (100) is connected to a common lead-out wire designated as a battery unit aggregate terminal B;
each temperature sensor comprises a case (101), a central shaft (102) and a bushing (103), wherein the central shaft (102) and the bushing (103) are provided in the case (101), and the case (101) is electrically insulated from the central shaft (102); the bushing (103) is a metal component comprising a fixed end (1031) fixedly connected to the central shaft (102), a sliding end (1033) slidably connected to the central shaft (102), and a thermally-responsive deformation segment (1032) located between the fixed end (1031) and the sliding end (1033), the thermally-responsive deformation segment (1032) is made of a temperature-variable metal material, and when the temperature reaches a deformation threshold of the thermally-responsive deformation segment (1032), the thermally-responsive deformation segment (1032) deforms to form an arch shape, so that the sliding end approaches the fixed end, and the thermally-responsive deformation segment (1032) abuts against the case (101) and is electrically connected to the case (101);
the case (101) comprises a metal case body (1011) and an end cap (1012) made of an electrically insulating material arranged at two ends of the metal case body (1011), and the central shaft (102) is detachably connected to the end cap (1012); the end cap (1012) is detachably connected to the case body (1011); the central shaft (102) is of a hollow tubular structure and is made of a metal material, and a unidirectional conducting diode (104) is encapsulated in the hollow of the central shaft (102), and an anode of the diode (104) is electrically connected to an inner side wall of the central shaft (102); the case further comprises two lead-out terminals of a terminal A (106) and a terminal B (105), wherein the terminal B (105) is electrically connected to the case (101), the terminal A (106) is electrically connected to a cathode of the diode (104), and the terminal A (106) is electrically insulated from the central shaft (102); the thermally-responsive deformation segment (1032) is a metal sheet made of a memory alloy or a bimetal sheet formed by superposing two bimetallic strips with different thermal expansion coefficients;
there are a plurality of metal sheets in the thermally-responsive deformation segment (1032), and the plurality of metal sheets are uniformly arranged in the circumferential direction of the central shaft (102); when deformed at a high temperature, the bushing (103) transforms into a lantern-frame-like structure, as illustrated in FIG. 2.

2. The lithium-ion battery according to claim 1, wherein the shape of the lithium-ion battery is cylindrical and the temperature sensor (100) is disposed in a cavity of a wound battery center core pillar (203).

3. The lithium-ion battery according to claim 1, wherein the lithium-ion battery is prismatic, and the temperature sensor (100) is disposed at a corner of an inner cavity of the lithium-ion battery.

4. A lithium-ion battery pack comprising a plurality of lithium-ion batteries according to claim 1, wherein the plurality of lithium-ion batteries are arranged in M rows and N columns to form a matrix;
a terminal A of each battery in a given row is connected to a common lead-out wire to form a row lead-out terminal, such that the battery pack comprises M row lead-out terminals corresponding respectively to the M rows;
a terminal B of each battery in a given column is connected to a common lead-out wire to form a column lead-out terminal, such that the battery pack comprises N column lead-out terminals corresponding respectively to the N columns;
whereby each battery in the matrix is located at a unique intersection of a given row and column, allowing its position in the matrix to be uniquely identified.

5. The method for detecting overheated batteries of a lithium-ion battery pack according to claim 4, comprising a matrix of M rows and N columns of lithium-ion batteries, each battery having a terminal A connected to a row lead-out terminal and a terminal B connected to a column lead-out terminal;
a first multiplexer (5011) having M input terminals and one first output terminal;
a second multiplexer (5012) having N input terminals and one second output terminal;
a power supply (502) serving as a DC working power supply for detecting the overheated lithium-ion batteries;
a fixed value resistor (503) having one end electrically connected to a second output terminal of the second multiplexer (5012) and the other end electrically connected to a positive electrode of the power supply (502);
a voltage meter (504) connected in parallel to the fixed value resistor (503);
the method for detecting overheated batteries comprises:
(a) electrically connecting M row lead-out terminals to respective input terminals of a first multiplexer having one output terminal;
(b) electrically connecting N column lead-out terminals to respective input terminals of a second multiplexer having one output terminal;
(c) connecting a power supply such that a negative electrode of the power supply is connected to the output terminal of the first multiplexer and a positive electrode of the power supply is connected to the output terminal of the second multiplexer through a fixed value resistor;
(d) connecting a voltage meter in parallel with the fixed value resistor;
(e) sequentially switching the input terminals of the first and second multiplexers to form connections between selected row and column lead-out terminals; and
(f) monitoring the voltage meter to detect an increase in voltage indicating overheating of the battery corresponding to the selected row and column pair.
